(19) United States
(12) Patent Application Publication
(10) Pub. No.: US 2008/0252622 A1
(43) Pub. Date: Oct. 16, 2008

(54) SYSTEMS FOR DISPLAYING IMAGES AND DRIVING METHOD THEREOF

(75) Inventors: Ya-Hsiang Tai, Hsinchu City (TW); Ksuan-Chun Ku, Changhua County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: TPO DISPLAYS CORP., Miao-Li County (TW)

(21) Appl. No.: 11/735,619

(22) Filed: Apr. 16, 2007

(51) Int. Cl. G09G 5/00

(52) U.S. Cl. 345/204

(57) ABSTRACT

Systems for displaying images. The system comprises a signal driving circuit with X+1 shift registers connected in series, generating X+1 output pulses in sequence according to a start pulse and a clock signal, and a logic unit coupled to the X+1 shift registers, generating Z driving signals in sequence according to the X+1 output pulses and Y enabling signals, wherein Y, X and Z are integers, Y>1, X>0 and Z>X.

### BACKGROUND OF THE INVENTION

1. Field of the Invention

The invention relates to panel displays, and in particular to systems for displaying images.

2. Description of the Related Art

Liquid crystal displays (LCDs) are used in a variety of applications including calculators, watches, color televisions, computer monitors, and many other electronic devices. Active matrix LCDs are a well known type of LCD. In a conventional active matrix LCD, each picture element (or pixel) comprises a thin film transistor (TFT) and one or more capacitors. The pixels are arranged and wired in an array having a plurality of rows and columns.

To address a particular pixel, the proper row is switched “on” (i.e., charged with a voltage), and a voltage is sent down the correct column. Since the other rows that a column intersects are turned off, only the TFT and capacitor at the particular pixel receive a charge. In response to the applied voltage, the liquid crystal within the cell of the pixel changes its rotation and tilt angle, and thus, the amount of light is absorbed or passing therethrough. This process then is repeated row by row. For example, a gate driver is required to scan the rows of pixels in sequence, and a data driver is required to provide data voltages to columns of pixels.

As resolution of AMLCD is increased, dot pitch in pixel array is decreased and more shift registers in gate driver are required to generate scan signals. In the conventional arrangement, however, the high resolution AMLCD suffers from the limited lateral layout area in the gate driver. Thus, when the resolution of the AMLCD is increased, layout difficulty in wire routing caused by shift registers increases accordingly.

### SUMMARY OF THE INVENTION

An embodiment of a system for displaying images, comprise a signal driving circuit with X+1 shift registers connected in series, generating X+1 output pulses in sequence according to a start pulse and a clock signal, and a logic unit coupled to the X+1 shift registers, generating Z driving signals in sequence according to the X+1 output pulses and Y enabling signals, wherein Y, X and Z are integers, Y>1, X>0 and Z≧X.

The invention also provides another embodiment of system for displaying images, in which the system comprises N+1 shift registers generating N+1 output pulses in sequence according to a start pulse and a clock, and 2N logic gates generating driving signals according to the output pulses from the shift registers, and first and second enabling signals. For example, a first logic gate generates a first driving signal according to the first output pulse, the second output pulse and a first enabling signal, and a second logic gate generates a second driving signal according to the first output pulse, the second output pulse and the second enabling signal. A third logic gate generates a third driving signal according to the second output pulse, the third output pulse and the first enabling signal, and a fourth logic gate generates a fourth driving signal according to the second output pulse, the third output pulse and the second enabling signal, and so fourth.

The invention also provides a driving method for displaying images, in which first, second, third output pulses and so forth are generated in sequence according to a start pulse and a clock signal, a first driving signal is generated according to the first and the second output pulses and a first enabling signal, and a second driving signal is generated according to the first and the second output pulses and a second enabling signal. A third driving signal is generated according to the second and third output pulses and the first enabling signal, and a fourth driving signal is generated according to the second third output pulses and the second enabling signals, and so fourth, wherein the driving signals are generated in sequence.

### BRIEF DESCRIPTION OF THE DRAWINGS

The invention can be more fully understood by reading the subsequent detailed description and examples with references made to the accompanying drawings, wherein:

FIG. 1 is a diagram of a signal driving circuit;

FIG. 2 shows an embodiment of a signal driving circuit;

FIG. 3 is a timing chart of the signal driving circuit shown in FIG. 2;

FIG. 4 shows another embodiment of a signal driving circuit;

FIG. 5 is a timing chart of the signal driving circuit shown in FIG. 4;

FIG. 6 shows an embodiment of a display system;

FIG. 7 schematically shows an embodiment of an electronic device; and

FIG. 8 schematically shows an embodiment of an electronic device.

### DETAILED DESCRIPTION OF THE INVENTION

This description is made for the purpose of illustrating the general principles of the invention and should not be taken in a limiting sense. The scope of the invention is best determined by reference to the appended claims.

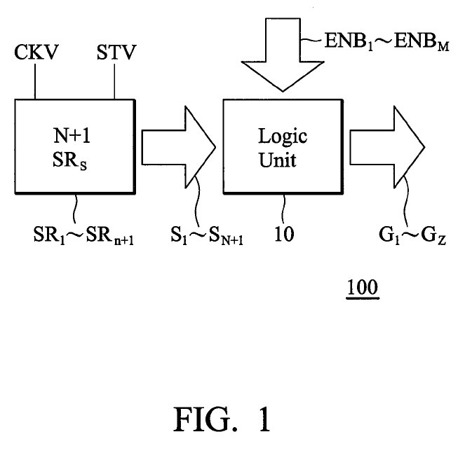

FIG. 1 is a diagram of a signal driving circuit. As shown, the signal driving circuit 100 can, for example, be a gate driver for providing driving signals G₁˜G_{Z} to a display panel (not shown). The signal driving circuit 100 comprises N+1 shift registers SR₁˜SRₙ₊₁ connected in series, generating N+1 output pulses in sequence according to a start pulse STV and a clock signal CKV and a logic unit 10 generating the driving signals G₁-G_{Z} in sequence according to the N+1 output pulses and M enabling signals, wherein M and N are positive integers, M>1, N>0, Z>N, and Z=N×M. For example, the logic unit 10 comprises logic gates, such as AND gates, OR gates, XOR gates, NOR gates or combinations thereof.

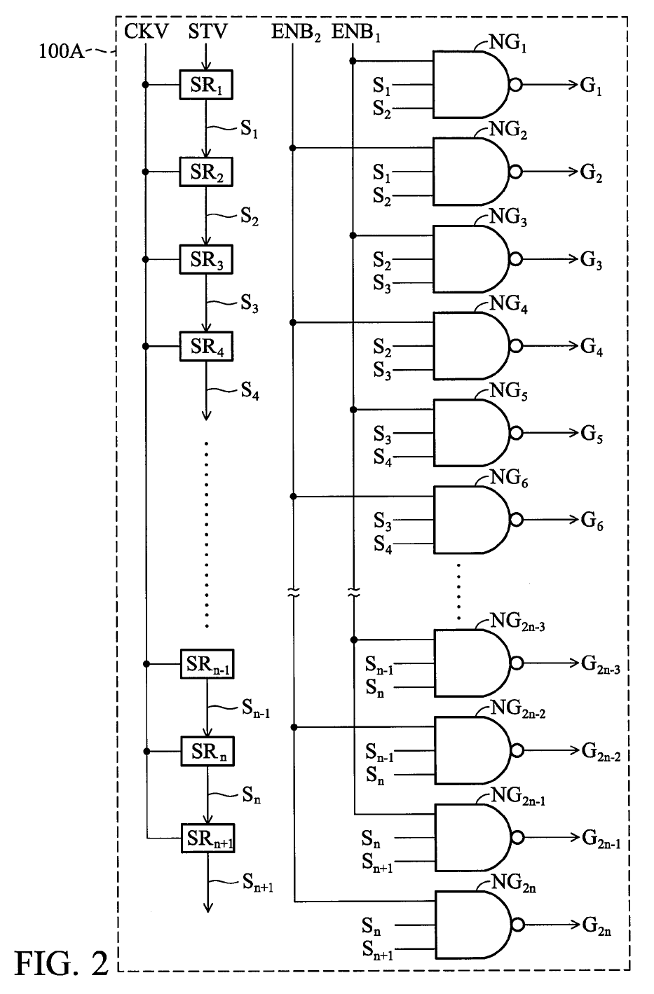

FIG. 2 shows an embodiment of a signal driving circuit. As shown, the signal driving circuit 100A comprises shift registers SR1˜SRn+1 and NOR gates NG1˜NG2n. The shift registers SR1˜SRn+1 generate output pulses S1˜Sn+1 in sequence according to the start pulse STV and the clock signal CKV. For example, the shift register SR1 generates an output pulse S1 according to the start pulse STV and the clock signal CKV, the shift register SR2 generates an output pulse S2 according to the output pulse S1 from the shift register SR1 and the clock signal CKV, the shift register SR3 generates an output pulse S3 according to the output pulse S2 from the shift register SR2 and the clock signal CKV, and so on.

The NOR gates NG1˜NG2n generate driving signal to a display panel (not shown) according to the output pulses S1˜Sn+1 and two enabling signals ENB1 and ENB2. For example, the NOR gate NG1 comprises three input terminals coupled to the output pulses S1 and S2 and the enabling signal ENB1 respectively, the NOR gate NG2 comprises three input terminals coupled to the output pulses S1 and S2 and the enabling signal ENB2 respectively, the NOR gate NG3 comprises three input terminals coupled to the output pulses S2 and S3 and the enabling signal ENB1 respectively, the NOR gate NG4 comprises three input terminals coupled to the output pulses S2 and S3 and the enabling signal ENB2 respectively, the NOR gate NG5 comprises three input terminals coupled to the output pulses S3 and S4 and the enabling signal ENB1 respectively, the NOR gate NG6 comprises three input terminals coupled to the output pulses S3 and S4 and the enabling signal ENB2 respectively, and so on.

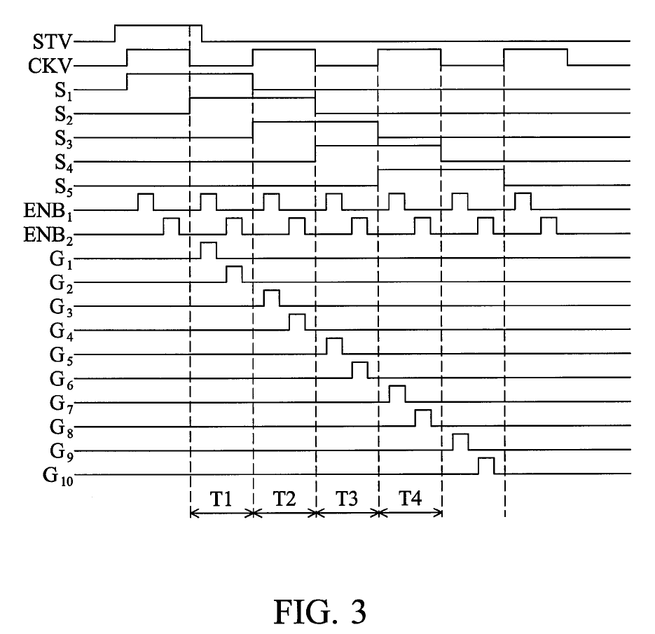

FIG. 3 is a timing chart of the signal driving circuit shown in FIG. 2. As shown, during period T1, the NOR gate NG1 generates the driving signal G1 when the output pulses S1 and S2 from the shift registers SR1 and SR2 and the enabling signal ENB1 go high. Similarly, the NOR gate NG2 generates the driving signal G2 when the output pulses S1 and S2 from the shift registers SR1 and SR2 and the enabling signal ENB2 go high, during period T1. Also, during period T2, the NOR gate NG3 generates the driving signal G3 when the output pulses S2 and S3 from the shift registers SR2 and SR3 and the enabling signal ENB1 go high, and the NOR gate NG4 generates the driving signal G4 when the output pulses S2 and S3 from the shift registers SR2 and SR3 and the enabling signal ENB2 go high.

During period T3, the NOR gate NG5 generates the driving signal G5 when the output pulses S3 and S4 from the shift registers SR3 and SR4 and the enabling signal ENB1 go high, and the NOR gate NG6 generates the driving signal G6 when the output pulses S3 and S4 from the shift registers SR3 and SR4 and the enabling signal ENB2 go high. During period T4, the NOR gate NG7 generates the driving signal G7 when the output pulses S4 and S5 from the shift registers SR4 and SR5 and the enabling signal ENB1 go high, and the NOR gate NG8 generates the driving signal G8 when the output pulses S4 and S5 from the shift registers SR4 and SR5 and the enabling signal ENB2 go high, and so on. Namely, the signal driving circuit 100A can generate 2n driving signals G1˜G2n by n+1 shift registers and two enabling signals without 2n+1 shift registers.

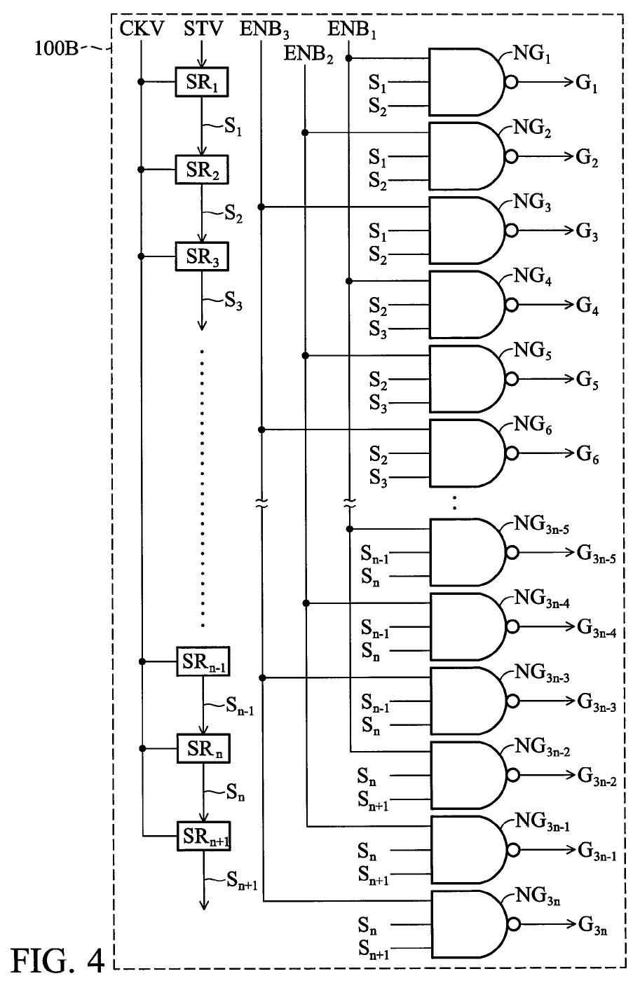

FIG. 4 shows another embodiment of a signal driving circuit. As shown, the signal driving circuit 100B comprises shift registers SR1˜SRn+1 and NOR gates NG1˜NG3n. The shift registers SR1˜SRn+1 generate output pulses S1˜Sn+1 in sequence according to the start pulse STV and the clock signal CKV. For example, the shift register SR1 generates an output pulse S1 according to the start pulse STV and the clock signal CKV, the shift register SR2 generates an output pulse S2 according to the output pulse S 1 from the shift register SR1 and the clock signal CKV, the shift register SR3 generates an output pulse S3 according to the output pulse S2 from the shift register SR and the clock signal CKV, and so on.

The NOR gates NG1˜NG3n generate driving signals to a display panel (not shown) according to the output pulses S1˜Sn+1 and three enabling signals ENB1˜ENB3. For example, the NOR gate NG1 comprises three input terminals coupled to the output pulses S1 and S2 and the enabling signal ENB1 respectively, the NOR gate NG2 comprises three input terminals coupled to the output pulses S1 and S2 and the enabling signal ENB2 respectively, and the NOR gate NG3 comprises three input terminals coupled to the output pulses S1 and S2 and the enabling signal ENB3 respectively. The NOR gate NG4 comprises three input terminals coupled to the output pulses S2 and S3 and the enabling signal ENB1 respectively, the NOR gate NG5 comprises three input terminals coupled to the output pulses S2 and S3 and the enabling signal ENB2 respectively, the NOR gate NG6 comprises three input terminals coupled to the output pulses S2 and S3 and the enabling signal ENB3 respectively, and so on.

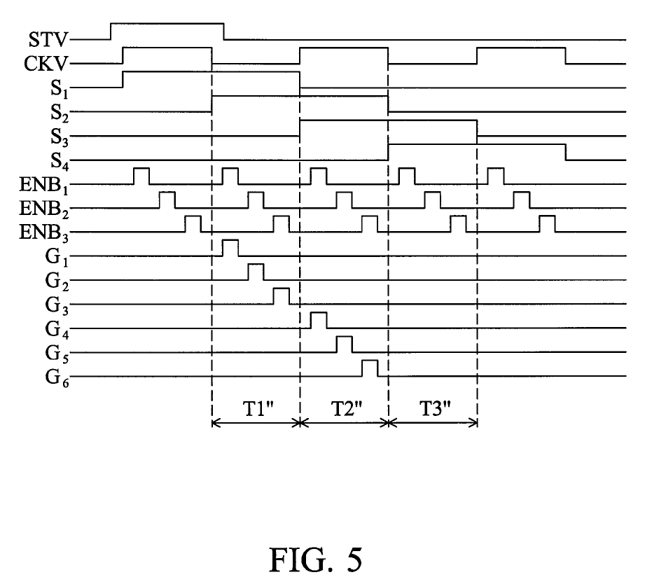

FIG. 5 is a timing chart of the signal driving circuit shown in FIG. 4. As shown, during period T1″, the NOR gate NG1 generates the driving signal G1 when the output pulses S1 and S2 from the shift registers SR1 and SR2 and the enabling signal ENB1 go high. Similarly, the NOR gate NG2 generates the driving signal G2 when the output pulses S1 and S2 from the shift registers SR1 and SR2 and the enabling signal ENB2 go high, and the NOR gate NG3 generates the driving signal G3 when the output pulses S1 and S2 from the shift registers SR1 and SR2 and the enabling signal ENB3 go high.

During period T2″, the NOR gate NG4 generates the driving signal G4 when the output pulses S2 and S3 from the shift registers SR2 and SR3 and the enabling signal ENB1 go high, and the NOR gate NG5 generates the driving signal G5 when the output pulses S2 and S3 from the shift registers SR2 and SR3 and the enabling signal ENB2 go high. Similarly, the NOR gate NG6 generates the driving signal G6 when the output pulses S2 and S3 from the shift registers SR2 and SR3 and the enabling signal ENB3 go high, and so on. Namely, the signal driving circuit 100B can generate 3n driving signals G1˜G3n by n+1 shift registers and three enabling signals without 3n+1 shift registers.

In the conversion gate driver, n+1 shift registers are required to generate n driving signals to driving scan lines in a display panel, 2n+1 shift registers are required to generate 2n driving signals, 3n+1 shift registers are required to generate 3n driving signals, and so on.

In the invention, because the signal driving circuit can generate 2n, 3n, 4n, 5n, . . . m×n driving signals with N+1 shift registers and m enabling signals, the number of shift registers in the signal driving circuit can be lower than in conventional signal driving circuits. Namely, as resolution of AMLCD is increased and dot pitch in pixel array is decreased, the invention generates more scan signals by more enabling signals and OR gates. Alternately, the invention can also be regarded as one shift register generating n driving signals by n enabling signals.

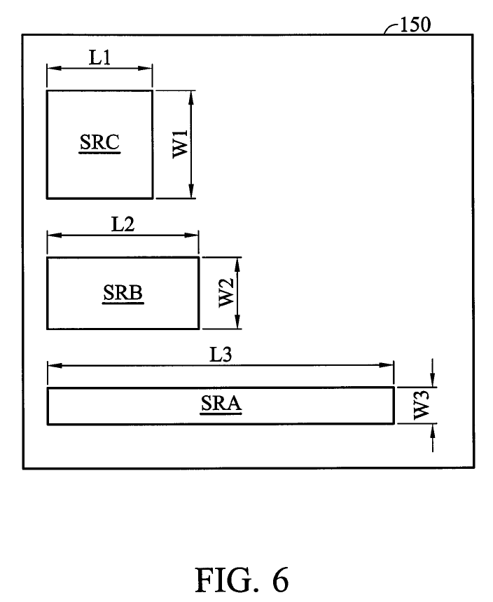

FIG. 6 shows different layouts of shift register with the same component. As shown, the shift register SRA has a length L3 of 865 μm and a width W3 of 90 μm, the shift register SRB has a length L2 of 378 μm and a width W2 of 180 μm, and the shift register SRC has a length L1 of 263 μm and a width W1 of 270 μm, each generating a driving signal. In a fixed layout area in the substrate 150, conventional gate drivers generates n driving signals by n+1 shift registers SRAs. In the invention, the signal driving circuit 100A generates n driving signals by two enabling signals and

$$\frac{n + 1}{2}$$

shift registers SRB, and the signal driving circuit 100B generates n driving signals by three enabling signals and

$$\frac{n + 1}{3}$$

shift registers SRC. Thus, the number of shift registers and the lateral layout area in the signal driving circuit (gate driver) are reduced for high resolution AMLCD. Thus, layout difficulty in wire routing caused by shift registers can be alleviated. It should be noted that, if the frequency of the clock signal CKV in the convention signal driving circuit is F0, the frequency of the clock signal CKV for the shift registers is

$$\frac{1}{M} F 0 ,$$

in which M is the number of enabling signals of the logic unit 10. For example, the frequency of the clock signal CKV in the signal driving circuit 100A is

$$\frac{1}{2} F 0 ,$$

and the frequency of the clock signal CKV in the signal driving circuit 100B is

$$\frac{1}{3} F 0 ,$$

and so on.

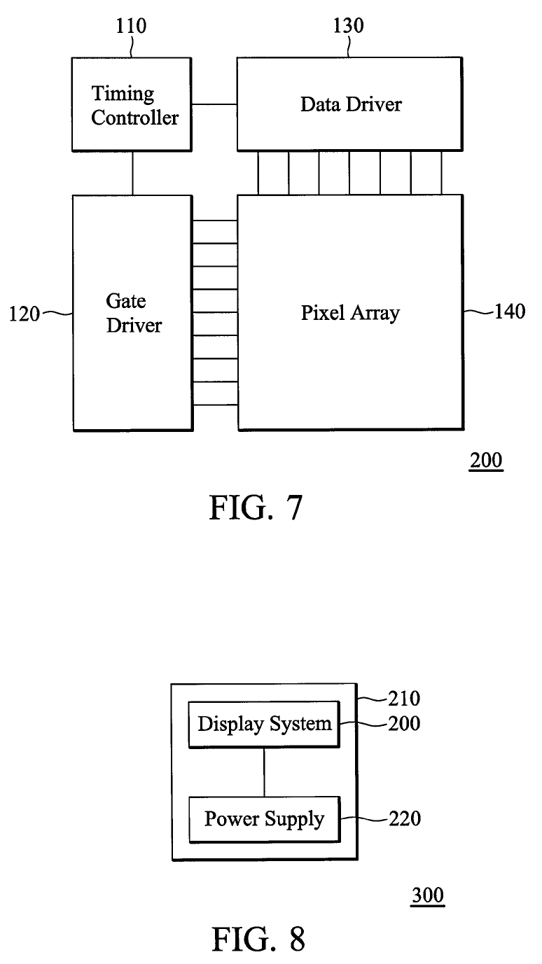

FIG. 7 shows an embodiment of a display system. As shown, the display system 200 comprises a timing controller 110, a gate driver 120, a data driver 130 and a pixel array 140. The timing controller 110 provides control signals to the gate driver 120 and the data driver 140, such that the gate driver 120 and the data driver 140 drive the pixel array to display images. For example, the timing controller 110 provides the start pulse STV and the clock signal CLV to the gate driver 120. The gate driver 120 can be implemented as the signal driving circuit 100/100A/100B to generate driving signals, driving the pixel array 140. The data driver 130 provides data voltages to the pixel array 140, such that the pixel array 140 displays images accordingly. For example, the pixel array 140 can be an organic light emitting pixel array, an electroluminescent pixel array or a liquid crystal pixel array but is not limited thereto.

FIG. 8 schematically shows an embodiment of an electronic device. In particular, electronic device 300 employs the display system 200 shown in FIG. 7. The electronic device 300 may be a device such as a PDA, digital camera, notebook computer, tablet computer, cellular phone or a display monitor device, for example. Generally, the electronic device 300 comprises a housing 210, a display system 200, and a power supply 220, although it is to be understood that various other components can be included, not shown or described here for ease of illustration and description. In operation, the power supply 220 powers the display system 200 to display color images.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for providing driving signals to a display element, comprising a signal driving circuit comprising:
X+1 shift registers connected in series, generating X+1 output pulses in sequence according to a start pulse and a clock signal; and
a logic unit coupled to the X+1 shift registers, generating Z driving signals in sequence according to the X+1 output pulses and Y enabling signals, wherein Y, X and Z are integers, Y>1, X>0 and Z≧X.

2. The system as claimed in claim 1, wherein Z=X×Y.

3. The system as claimed in claim 1, wherein the logic unit comprises X×Y NOR gates each comprising a first input terminal coupled to one of the Y enabling signals, a second input terminal, and a third input terminal coupled to two corresponding output pulses from the shift registers.

4. The system as claimed in claim 1, wherein the signal driving circuit is implemented as a gate driver.

5. The system as claimed in claim 1, further comprising a display panel, wherein the gate driver is a portion of the display panel.

6. The system as claimed in claim 5, wherein the display panel is an organic light emitting panel or a LCD panel.

7. The system as claimed in claim 5, further comprising an electronic device, wherein the electronic device comprises:
the display panel; and
a power supply powering the display panel to display images.

8. The system as claimed in claim 7, wherein the system is implemented as a PDA, a display monitor, a notebook computer, digital camera, car display, a tablet computer or a cellular phone.

9. A system for displaying images, comprising a signal driving circuit comprising:
a first shift register generating a first output pulse according to a start pulse and a clock signal;
a second shift register generating a second output pulse according to the first output pulse and the clock signal;
a first logic gate generating a first driving signal according to the first output pulse, the second output pulse and a first enabling signal; and
a second logic gate generating a second driving signal according to the first output pulse, the second output pulse and a second enabling signal.

10. The system as claimed in claim 9, wherein the signal driving circuit further comprises:
a third shift register generating a third output pulse according to the second output pulse and the clock signal;
a third logic gate generating a third driving signal according to the second output pulse, the third output pulse and the first enabling signal; and
a fourth logic gate generating a fourth driving signal according to the second output pulse, the third output pulse and the second enabling signal.

11. The system as claimed in claim 10, wherein the signal driving circuit further comprises:
a fourth shift register generating a fourth output pulse according to the third output pulse and the clock signal;
a fifth logic gate generating a fifth driving signal according to the third output pulse, the fourth output pulse, and the first enabling signal; and
a sixth logic gate generating a sixth driving signal according to the third output pulse, the fourth output pulse, and the second enabling signal.

12. The system as claimed in claim 11, wherein the first, the second, the third, the fourth, the fifth and the sixth logic gates comprise OR gates.

13. The system as claimed in claim 9, wherein the signal driving circuit is implemented as a gate driver.

14. The system as claimed in claim 9, wherein the signal driving circuit further comprises a third logic gate generating a third driving signal according to the first output pulse, the second output pulse and a third enabling signal.

15. The system as claimed in claim 14, wherein the signal driving circuit further comprises:
a third shift register generating a third output pulse according to the second output pulse and the clock signal;
a fourth logic gate generating a fourth driving signal according to the second output pulse, the third output pulse and the first enabling signal;
a fifth logic gate generating a fifth driving signal according to the second output pulse, the third output pulse and the second enabling signal; and
a sixth logic gate generating a sixth driving signal according to the second output pulse, the third output pulse and the third enabling signal.

16. The system as claimed in claim 15, wherein the first, the second, the third, the fourth, the fifth and the sixth logic gates comprise OR gates.

17. A driving method of a system for displaying images, comprising:
generating first, second and third output pulses in sequence according to a start pulse and a clock signal;
generating a first driving signal according to the first and the second output pulses and a first enabling signal; and
generating a second driving signal according to the first and the second output pulses and a second enabling signal, wherein the first and the second driving signals are generated in sequence.

18. The method as claimed in claim 17, further comprising:
generating a third driving signal according to the second and the third output pulses and the first enabling signal; and
generating a fourth driving signal according to the second and the third output pulses and the second enabling signal, wherein the first to the fourth driving signals are generated in sequence.

19. The method as claimed in claim 17, further comprising generating a third driving signal according to the first and the second output pulses and a third enabling signal, wherein the first to the third driving signals are generated in sequence.

20. The method as claimed in claim 19, further comprising:
generating a fourth driving signal according to the second and the third output pulses and the first enabling signal;
generating a fourth driving signal according to the second and the third output pulses and the second enabling signal; and
generating a fourth driving signal according to the second and the third output pulses and the third enabling signal, wherein the first to the sixth driving signals are generated in sequence.
